(19) United States
(12) Patent Application Publication
(10) Pub. No.: US 2026/0244126 A1
(43) Pub. Date: Aug. 20, 2026

(54) IMAGE FORMING APPARATUS

(71) Applicant: CANON KABUSHIKI KAISHA, Tokyo (JP)

(72) Inventors: YUYA KINO, Shizuoka (JP); MASATOSHI ITOH, Shizuoka (JP)

(21) Appl. No.: 19/541,969

(22) Filed: Feb. 17, 2026

(30) Foreign Application Priority Data
Feb. 14, 2025 (JP) 2025-022911

(51) Int. Cl. G03G 15/08; G03G 15/00

(52) U.S. Cl. CPC G03G 15/086; G03G 15/0863; G03G 15/0889; G03G 15/80

(57) ABSTRACT

An image forming apparatus includes a developing device and a main assembly including a voltage applying portion, an output portion, an adjusting portion, an acquiring portion, a notifying portion, and a controller. In a case where a signal output when a stirring operation is performed is a first signal, an acquisition value based on the first signal is a first acquisition value, and a signal output when the stirring operation is not performed is a second signal, the adjusting portion makes adjustment of at least one of the output portion and the voltage applying portion so that strength of the second signal falls within a predetermined range, and the notifying portion makes notification depending on the first acquisition value based on the first signal output in a state in which the adjustment is made and the strength of the second signal is within the predetermined range.

### BACKGROUND

### Field of the Technology

The present disclosure relates to an image forming apparatus utilizing an electrophotographic process.

### Description of the Related Art

The image forming apparatus of the electrophotographic type forms an image on a recording material by transferring a toner image, formed on a surface of a photosensitive drum by using a developer such as toner, onto a transfer(-receiving) material such as paper. In such an image forming apparatus, a constitution including a toner accommodating portion for accommodating the toner and a toner amount detecting means for detecting a toner amount of the toner inside the toner accommodating portion (herein, this toner amount is also referred to as a “remaining toner amount”) has been known.

In Japanese Laid-Open Patent Application No. Hei02-197879, a toner amount detecting means of an capacitance type is disclosed. Electrostatic capacity is constituted by providing a stirring rod consisting of two (electroconductive) lead wire members in a toner accommodating portion. When the stirring rod is rotated, a state in which there is toner between the two lead wire members and a state in which there is no toner between the two lead wire members are repeated, so that the capacitance is changed. This change in capacitance is converted into a voltage, and the voltage is monitored. The monitored voltage becomes a pulse with the same cyclic period as a rotation cyclic period, and a duty of this pulse is detected, so that a toner amount of the toner inside the toner accommodating portion can be detected.

### SUMMARY

The present disclosure is directed to maintain accuracy of information on an acquired toner amount irrespective of variations in component parts, a change in environment, or the like in a constitution in which the information on the toner amount is acquired by an capacitance type (system).

This is achieved by an image forming apparatus according to the present disclosure. According to an aspect of the present disclosure, there is provided an image forming apparatus comprising: (i) a developing device including: a roller that carries toner; an accommodating portion configured to accommodate the toner for being carried on the roller; a first electrode and a second electrode opposed to each other in the accommodating portion; and a stirring member configured to stir the toner in the accommodating portion, wherein the stirring member is rotated so that the toner is supplied to between the first electrode and the second electrode; and (ii) a main assembly to which the developing device is mounted, the main assembly including: a voltage applying portion configured to apply an AC voltage to the first electrode and the second electrode; an output portion configured to output a signal depending on capacitance between the first electrode and the second electrode; an adjusting portion configured to adjust at least one of the output portion and the voltage applying portion; an acquiring portion configured to acquire an acquisition value based on the signal; a notifying portion configured to notify information on a remaining toner amount of the accommodating portion, depending on the acquisition value; and a controller configured to control the voltage applying portion, the output portion, the adjusting portion, and the acquiring portion, wherein in a case where a signal output by the output portion when a stirring operation by the stirring member is performed is a first signal, an acquisition value based on the first signal is a first acquisition value, and a signal output by the output portion when the stirring operation is not performed is a second signal, (a) the adjusting portion makes adjustment of at least one of the output portion and the voltage applying portion so that strength of the second signal falls within a predetermined range, and (b) the notifying portion makes notification depending on the first acquisition value based on the first signal output by the output portion in a state in which the adjustment is made and the strength of the second signal is within the predetermined range.

Features of the present disclosure will become apparent from the following description of embodiments with reference to the attached drawings. The following description of embodiments are described by way of example.

### BRIEF DESCRIPTION OF THE DRAWINGS

FIG. 1 is a sectional view showing a schematic constitution of an image forming apparatus.

Parts (a) and (b) of FIG. 2 are sectional views showing a schematic constitution of a developing device.

FIG. 3 is a schematic view showing a detecting constitution of a remaining toner amount.

FIG. 4 is a graph showing a relationship between capacitance C and an output voltage Vsns and an illustration showing a waveform of the output voltage Vsns of an capacitance detecting portion.

FIG. 5 is a schematic view for illustrating a table showing a relationship between a duty ratio and the remaining toner amount.

Parts (a) and (b) of FIG. 6 are schematic views each showing a waveform of the output voltage of the capacitance detecting portion for illustrating conversion to a Hi/Lo operation signal.

FIG. 7 is a flowchart for illustrating procedure of output voltage Vsns adjustment control.

FIG. 8 is a schematic view showing a waveform of the output voltage of the capacitance detecting portion for illustrating the procedure of the output voltage Vsns adjustment control.

FIG. 9 is a schematic view showing a waveform of the output voltage of the capacitance detecting portion for illustrating a setting method of an abnormality discrimination threshold voltage.

Parts (a) and (b) of FIG. 10 are graphs for illustrating abnormality detection ranges in an embodiment and a comparison example.

FIG. 11 is a schematic view for illustrating another example of the image forming apparatus.

### DESCRIPTION OF THE EMBODIMENTS

In the following, an image forming apparatus according to the present disclosure will be described more specifically with reference to the drawings.

### Embodiment 1

### Constitution of Image Forming Apparatus

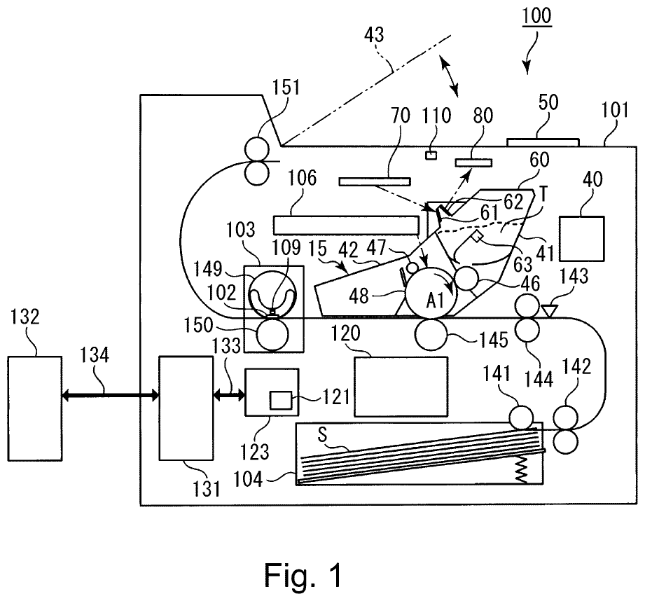

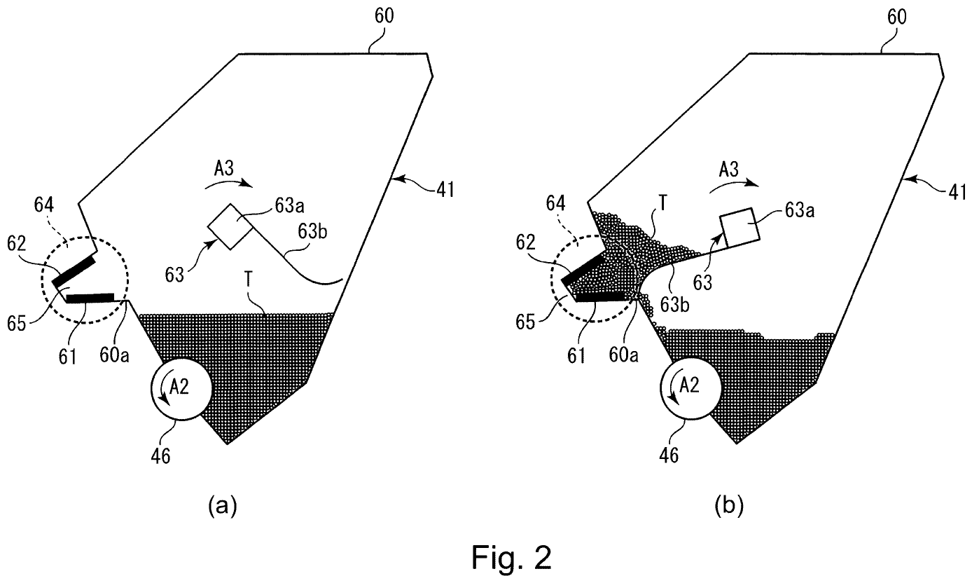

FIG. 1 is a sectional view showing a schematic constitution of an image forming apparatus 100 of this embodiment. In this embodiment, the image forming apparatus 100 is a laser beam printer as an example of an image forming apparatus using an electrophotographic process. Incidentally, the image forming apparatus using the electrophotographic process may be, for example, a copying machine, a printer, a facsimile machine, or a multi-function machine having a plurality of functions of those of these machines.

An apparatus main assembly 101 of the image forming apparatus 100 includes a sheet (paper) feeding cassette 104 for accommodating recording materials S (recording media, transfer(-receiving) materials, sheets) such as paper or plastic sheets. In addition, the apparatus main assembly 101 includes a sheet feeding roller 141 for feeding the recording material S from the sheet feeding cassette 104 and a sheet conveying roller pair 142 for conveying the recording material S fed by the sheet feeding roller 141. Further, the apparatus main assembly 101 includes a top sensor 143 for detecting a leading end of the recording material S and a registration roller pair 144 for synchronously conveying the recording material S, which are provided downstream of the conveying roller pair 142 with respect to a conveying direction of the recording material S.

Further, the apparatus main assembly 101 includes a cartridge unit (process cartridge) 15 provided downstream of the registration roller pair 144 with respect to the conveying direction of the recording material S. The cartridge unit 15 is detachably mountable to the apparatus main assembly 101. The cartridge unit 15 includes a photosensitive drum 48 as an image bearing member, a primary charging roller 47, a developing device 41, a cleaning device 42, and the like. Further, the apparatus main assembly 101 includes a laser scanner provided above the cartridge unit 15 in FIG. 1. Further, the apparatus main assembly 101 includes a transfer roller 145 provided below the cartridge unit 15 in FIG. 1 so as to contact the photosensitive drum 48.

The photosensitive drum 48 is rotated in an arrow A1 direction (clockwise direction) in FIG. 1. A surface of the rotating photosensitive drum 48 is electrically charged uniformly by the primary charging roller 47. The charged surface of the photosensitive drum 48 is scanned with and exposed to laser light from the laser scanner 106, so that an electrostatic latent image (electrostatic image) is formed on the photosensitive drum 48. The electrostatic latent image formed on the photosensitive drum 48 is developed by being supplied with toner as a developer by the developing device 41, so that a toner image is formed on the photosensitive drum 48. The toner image formed on the photosensitive drum 48 is transferred onto the recording material S in a transfer portion where the photosensitive drum 48 and the transfer roller 145 are in contact with each other. Toner remaining on the photosensitive drum 48 without being transferred on the recording material S is removed and collected from the photosensitive drum 48 by the cleaning device 42.

The apparatus main assembly 101 includes a heat fixing device 103 for heat-fixing the toner image, formed on the recording material S, on the recording material S in a downstream side of the cartridge unit 15 with respect to the conveying direction of the recording material S. The heat fixing device 103 includes a fixing film 149, a pressing roller 150, a heater 102 provided on an inner peripheral surface side of the fixing film 149, and a thermistor 109 for detecting a temperature of the heater 102. The thermistor 109 is disposed in the neighborhood of the heater 102 on the inner peripheral surface side of the fixing film 149 so as to detect the temperature of the heater 102. Further, the apparatus main assembly 101 includes a sheet discharging roller pair 151 on a side downstream of the heat fixing device 103 with respect to the conveying direction of the recording material S.

The recording material S on which the toner image is transferred is conveyed to the heat fixing device 103. The heat fixing device 103 heats and presses the recording material S in a fixing portion where the fixing film 149 and the pressing roller 150 are in contact with each other, so that the toner image is heat-fixed on the recording material S. The recording material S on which the toner image is fixed is discharged (output) onto a discharge portion provided in an upper portion, in FIG. 1, of the apparatus main assembly 101 by the discharging roller pair 151.

Further, the apparatus main assembly 101 includes a power source unit (power source device) 120. The power source unit 120 is capable of appropriately outputting a voltage of 24 V and a voltage of 10 V in a switching manner, and generates the voltage of 24 V in an operation in a print mode or an operation in a stand-by mode. Further, the power source unit 120 supplies the voltage of 24 V as a driving system voltage to each of portions of the image forming apparatus 100 through an engine controller 123 described later. As these portions, it is possible to cite a driving unit 40 provided with a motor, a clutch, and the like; a high-voltage power source (not shown) for supplying a high voltage to the cartridge unit 15; a polygon mirror driving portion (not shown) for the laser scanner 106; and the like.

Further, the apparatus main assembly 101 includes the engine controller 123 for carrying out control of the apparatus main assembly 101. The engine controller 123 controls the driving unit 40, whereby the engine controller 123 controls conveyance of the recording material S by operating various rollers. In addition, the engine controller 123 controls the driving unit 40, whereby the engine controller 123 controls the laser scanner 106, the cartridge unit 15, the heat fixing device 103, and the like. Thus, the engine controller 123 is capable of causing the image forming apparatus 100 to perform an image forming operation (hereinafter, also referred to as “printing”). Further, the engine controller 123 mounting a DC-DC converter 121 inside thereof, and generates a voltage of 3.3 V, mainly used in a control system, on the basis of a voltage supplied from the power source unit 120. Further, this voltage of 3.3 V is supplied to a control circuit (not shown) provided inside thereof, and a circuit of a control system including a video controller 131 described later, a laser light emitting portion (not shown) of the laser scanner 106, a top sensor 143, and the like.

Further, the apparatus main assembly 101 includes the video controller 131. The video controller 131 is connected to the engine controller 123 through an engine interface 133, and in addition, is connected to an external device 132 such as a personal computer through a general-purpose external interface 134 (such as USB).

The video controller 131 receives print information (such as the number of printed sheets and various settings) and data for printing through the external interface 134. The video controller 131 mounts an image control (not shown) inside thereof, and by this image controller, the video controller 131 develops the data for printing received through the external interface 134 into image data of the image printable in the image forming apparatus 100. Thereafter, in a predetermined timing, the engine controller 123 receives the image data from the video controller 131 through the engine interface 133, and then sends the image data to the laser scanner 106.

In this embodiment, as described later, the engine controller 123 has functions as an adjusting portion for adjusting at least one of an output portion (capacitance detecting portion) 80 and a voltage applying portion (AC voltage output portion) 70 and as an acquiring portion for acquiring an acquisition value (remaining toner amount) based on a signal output by the output portion 80.

Further, the image forming apparatus 100 includes an openable/closable door 43 which opens an inside of the image forming apparatus 100 and which enables access to the inside of the image forming apparatus 100. The access to the inside of the image forming apparatus 100 includes, for example, that an operator puts his/her in the inside of the image forming apparatus 100 in order to exchange the cartridge unit 15 or clear a jam (paper jam) or that the operator checks (visually checks) the inside of the image forming apparatus 100 in order to check a mounting state of the cartridge unit 15 or check occurrence/non-occurrence of the jam.

### Developing Device

Parts (a) and (b) of FIG. 2 are sectional views showing a schematic constitution of the developing device 41 in this embodiment. Parts (a) and (b) of FIG. 2 schematically shows a state when a toner amount (remaining toner amount) of the toner inside a toner accommodating portion 60 described later. In this embodiment, the time when the remaining toner amount becomes small is a time when the remaining toner amount becomes 30% or less in the case where the remaining toner amount in an initial state (unused state or the like) is taken as 100%, or the like time.

The developing device 41 includes the toner accommodating portion 60 which is an accommodating portion for accommodating toner T and a developing roller 46 as a developing member for supplying the toner T, accommodated in the toner accommodating portion 60, to the photosensitive drum 48. The developing roller 46 is rotated in an arrow A2 direction (counterclockwise direction) in FIG. 2 and conveys the toner, accommodated in the toner accommodating portion 60, to a developing portion contacting the photosensitive drum 48 while carrying the toner on the surface thereof, so that the developing roller 46 supplies the toner to the electrostatic latent image on the photosensitive drum 48.

Further, inside the toner accommodating portion 60, a first electrode 61 and a second electrode 62 which are lead wire members constituting an capacitance portion 64, and a stirring member 63 are provided. The first electrode 61 and the second electrode 62 are mounted opposed each other in a recessed portion 60a which is provided in the toner accommodating portion 60 and which is recessed in the direction from an inside to an outside of the toner accommodating portion 60. The first electrode 61 and the second electrode 62 are fixed to an inner wall (wall surface) of the toner accommodating portion 60 constituting the recessed portion 60a. The stirring member 63 includes a shaft portion 63a rotatable about a rotational axis extending substantially parallel to a rotational axis of the photosensitive drum 48 and a rotational axis of the developing roller 46, and includes a sheet-like stirring portion (stirring blade) 63b fixed to the shaft portion 63a. The stirring member 63 is rotated in an arrow A3 direction (clockwise direction) in FIG. 2 and stirs the toner. Incidentally, the developing roller 46 and the stirring member 63 of the developing device 41 are rotationally driven by transmitting thereto a driving force from the driving unit 40. The stirring member 63 stirs the toner T, inside the toner accommodating portion 60, by a periodical stirring operation. Incidentally, in this embodiment, the periodical stirring operation for stirring the toner T inside the toner accommodating portion 60 by the stirring member 63 is a rotating operation, but may also be a reciprocating operation, a swinging operation, or the like.

Part (a) of FIG. 2 shows a state in which the toner T is in a bottom (surface) of the toner accommodating portion 60, and in this state, the toner T is not filled in a toner detecting portion 65 as a developer detecting portion which is an opposing space between the first electrode 61 and the second electrode 62 constituting the capacitance portion 64. On the other hand, part (b) of FIG. 2 shows a state in which the toner is raised by the stirring member 63 and is filled in the toner detecting portion 65. Thus, the developing device 41 is capable of taking a first state in which a space of the toner detecting portion 65 is filled in the toner T stirred by the stirring member 63 and a second state in which the space of the toner detecting portion 65 is not filled with the toner T. Incidentally, the developing device 41 is also capable of taking a state during transmission from the state in which the toner detecting portion 65 is filled with the toner T to the state in which the toner detecting portion 65 is not filled with the toner T, and a state during transition from the state in which the toner detecting portion 65 is not filled with the toner T to the state in which the toner detecting portion 65 is filled with the toner T.

In the following, the first state in which the toner detecting portion 65 is not filled with the toner as shown in part (a) of FIG. 2 is also referred to as a “state in which there is no toner in the toner detecting portion 65”, and the second state in which the toner detecting portion 65 is filled with the toner as shown in part (b) of FIG. 2 is also referred to as a “state in which there is toner in the toner detecting portion 65”. The capacitance of the capacitance portion 64 in the state in which there is no toner in the toner detecting portion 65 is defined as CO, the capacitance of the capacitance portion 64 in the state in which there is toner in the toner detecting portion 65 is defined as CI, and relative dielectric constant between air and the toner T is defined as εr. At this time, a relationship represented by the following formula (1) holds.

CI=εrCO (1)

In a state in which the remaining toner amount is small as shown in parts (a) and (b) of FIG. 2, during the rotation of the stirring member 63, a change in capacitance of the capacitance portion 64 is repeated with a (cyclic) period in which the stirring member 63 is rotated (hereinafter, this period is referred to as a “rotation period” or a “stirring period”).

### Detection of Remaining Toner Amount

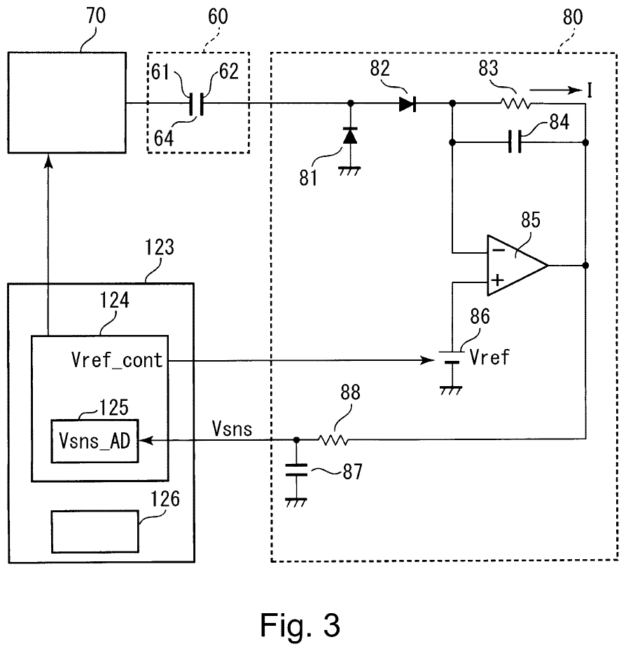

Next, detection of the remaining toner amount in this embodiment will be described. FIG. 3 is a schematic view showing a detection constitution of the remaining toner amount in this embodiment. In this embodiment, the image forming apparatus 100 detects the remaining toner amount by using the capacitance detecting portion 80 which is an example of a toner amount detecting means of an capacitance type.

As shown in FIG. 3, the detection constitution of the remaining toner amount is constituted by including the toner accommodating portion 60, the engine controller 123, the AC voltage output portion 70, and the capacitance detecting portion 80. The capacitance detecting portion 80 includes rectifying diodes 81 and 82, a detecting resistor 83, a rectifying capacitor 84, an operational amplifier 85, and a DC power source 86 for outputting a reference voltage Vref. The capacitance detecting portion 80 is connected to the capacitance portion 64 and a CPU 124 as a controller provided in the engine controller 123, and detects a voltage Vsns described later by an AD converter 125 provided inside the CPU 124. Incidentally, a detection range of the AD converter 125 in this embodiment is 0 V to 3.3 V. Incidentally, as regards a numerical range, “to” means that numerical values before and after “to” are included in the numerical range. The AC voltage output portion 70 constitutes a voltage applying portion for applying an AC voltage to the first electrode 61 and the second electrode 62. The CPU 124 is capable of variably changing Vpp (peak-to-peak voltage) and a frequency f of an AC voltage output from the AC voltage output portion 70 (hereinafter, this voltage is referred to as a “remaining (toner) amount detection AC voltage”), and a value of the reference voltage Vref, which are parameters determining an output characteristic of the capacitance detecting portion 80.

The remaining amount detection AC voltage is applied to the capacitance, so that an AC current depending on the capacitance of the capacitance portion 64 flows through the capacitance portion 64. This AC current is rectified by the rectifying diodes 81 and 82 and the rectifying capacitor 84. To a non-inversion input terminal (hereinafter referred to a “(+) terminal”) of the operational amplifier 85, the reference voltage Vref which is a DC voltage inputted from the DC power source 86 is applied. An inversion input terminal (hereinafter referred to as a “(−) terminal”) of the operational amplifier 85 is in an imaginary short relationship with the (+) terminal, and therefore, a state in which the (−) terminal has substantially the same potential as that of the (+) terminal. The voltage Vsns inputted from the capacitance detecting portion 80 to the CPU 124 becomes a voltage value dropped in voltage correspondingly to a DC current flowing from a voltage (reference voltage Vref) of the (−) terminal of the operational amplifier 85 to the detecting resistor 83.

That is, the rectifying diodes 81 and 82, the rectifying capacitor 84, the operational amplifier 85, the DC power source 86, and the detecting resistor 83 output the voltage Vsns depending on a current inputted from the capacitance portion 64. For this reason, these means function as a converting portion for converting a detection result of the capacitance detecting portion 80.

Incidentally, the capacitance detecting portion 80 includes a resistor 88 and a capacitor 87 which are for stabilizing a signal or the like, in an input passage of the voltage Vsns to the CPU 124.

A current I flowing through the detecting resistor 83 is equal to a current flowing through the capacitance portion 64. An electric charge Q accumulated in the capacitance C of the capacitance portion 64 is expressed by Q=C×V when a voltage applied to a cathode side of the rectifying diode 81 is defined as V. Further, Q=∫I(t)dt, and from these relationships, the current I flowing through the detecting resistor 83 can be acquired. The current I flowing through the detecting resistor 83 is represented by the following formula (2) when the capacitance of the capacitance portion 64 is defined as C, an amplitude voltage and a frequency of the remaining amount detection AC voltage are defined as VPP and f, respectively, the voltage (reference voltage) of the DC power source 86 is defined as Vref, and a forward voltage of each of the rectifying diodes 81 and 82 is defined as VF.

I=Cf(VPP−Vref−2VF) (2)

Or, the current I can also be represented by the following formula (3) when a resistance value of the detecting resistor 83 is defined as R.

I=(Vref−Vsns)/R (3)

When the formulas (2) and (3) are arranged by erasing I from these formulas, the following formula (4) is derived.

C=(Vref−Vsns)/{Rf(Vpp−Vref−2VF)} (4)

Therefore, by employing the constitution as shown in FIG. 3, the CPU 124 is capable of detecting a change in capacitance C of the capacitance portion 64 as a change in voltage (hereinafter referred to as an “output voltage”) Vsns output from the capacitance detecting portion 80. The capacitance detecting portion 80 constitutes an output portion for outputting a signal depending on an capacitance between the first electrode 61 and the second electrode 62.

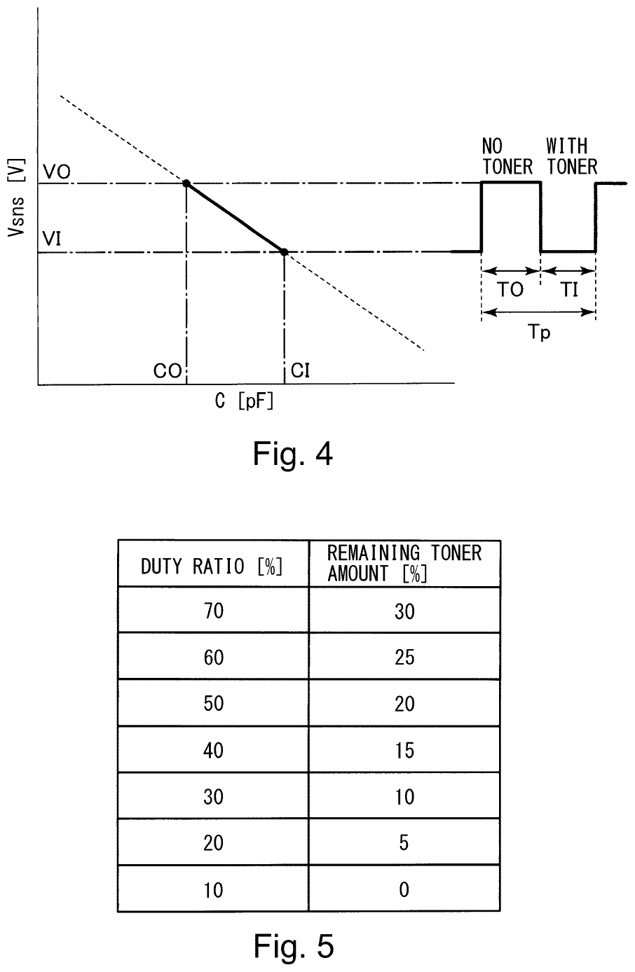

FIG. 4 is a graph showing a relationship between the capacitance C of the capacitance portion 64 shown in the formula (4) and the output voltage Vsns, and in an illustration showing a waveform of the output voltage Vsns of the capacitance detecting portion 80. In the graph of FIG. 4, an abscissa represents the capacitance C [pF], and an ordinate represents the output voltage Vsns [V].

As indicated by a broken line in FIG. 4, a detection range of the output voltage Vsns is detected by the capacitance CO in a state in which there is no toner T in the toner detecting portion 65 and the capacitance CI in a state in which there is toner T in the toner detecting portion 65. Here, the provided Vsns in the case where the capacitance C of the capacitance portion 64 is the capacitance CO in the state in which there is no toner T in the toner detecting portion 65 is defined as VO, and the output voltage Vsns in the case where the capacitance C of the capacitance portion 64 is the capacitance CI in the state in which there is toner T in the toner detecting portion 65 is defined as VI.

The waveform shown on a right side of the graph of FIG. 4 is the waveform of the output voltage Vsns of the capacitance detecting portion 80 in a state in which the stirring member 63 is rotated. This waveform is obtained by converting the output voltage Vsns detected by the AD converter 125 (hereinafter, this output voltage is referred to as “Vsns_AD”) into Hi/Lo pulse signal, in which the abscissa represents a time, and the ordinate represents the output voltage Vsns. A (cyclic) period of this waveform becomes a rotation period Tp, and an amplitude of this waveform becomes a detection range of the output voltage Vsns (VI≤Vsns≤VO). A ratio between a time TO in the state in which there is no toner T in the toner detecting portion 65 and a time TI in the state in which there is toner T in the toner detecting portion 65 correlates with a remaining amount of the toner T inside the toner accommodating portion 60. The CPU 124 measures the times TO and TI by a timer provided inside the CPU 124 with an edge of the Hi/Lo pulse signal as a trigger. Then, the CPU 124 calculates a ratio between a rotation period Tp and the time TI in the state in which there is toner T (hereinafter, this ratio is referred to as a “Duty ratio”), i.e., TI/(TO+TI). Then, on the basis of the calculated Duty ratio (TI/(TO+TI)), the CPU 124 detects a remaining toner amount by making reference to a table showing a relationship between the Duty ratio and the remaining toner amount, stored in advance in a storing portion 126. Thus, the CPU 124 discriminates an amount of the toner T in the toner accommodating portion 60 on the basis of a voltage waveform of the voltage output from the capacitance detecting portion 80. Specifically, the CPU 124 detects the remaining toner amount on the basis of a voltage waveform output in a state in which the toner detecting portion 65 is filled with the toner T stirred by the stirring member 63 and a voltage waveform output in a state in which the toner detecting portion 65 is not filled with the toner T stirred by the stirring member 63. Incidentally, the CPU 124 may start the measurement by the timer with a rising edge of the Hi/Lo pulse signal as the trigger and may start the measurement by the timer with a lowering edge of the Hi/Lo pulse signal as the trigger. In addition, the CPU 124 may also perform timer measurement with each of a rising edge and a lowering edge of Vsns_AD before the conversion into the Hi/Lo pulse signal.

### Remaining Toner Amount Detection Control

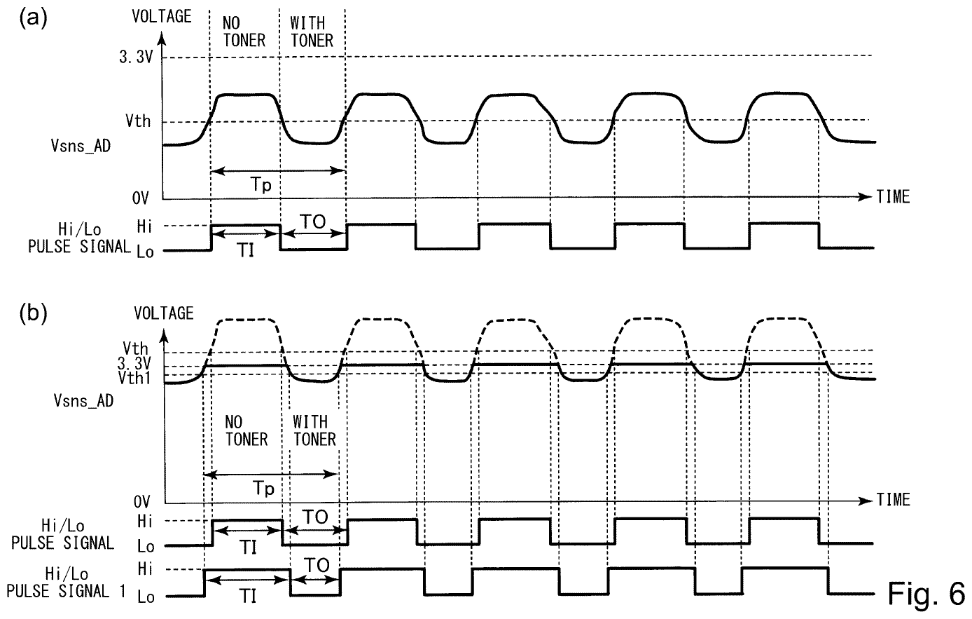

Next, an example of control for detecting the remaining toner amount in this embodiment (hereinafter, this control is referred to as “remaining toner amount detection control”) will be described. FIG. 5 is a schematic view showing an example of a table showing a relationship between the Duty ratio (TI/(TO+TI) and the remaining toner amount, stored in advance in the storing portion 126.

The table of FIG. 5 shows the Duty ratio [%] in a first column, and the remaining toner amount [%] in a second column. For example, in the case where the calculated Duty ratio is 70%, by making reference to the table of FIG. 5, the CPU 124 detects that the remaining toner amount is 30%. The CPU 124 carries out control so as to notify a user of the detected remaining toner amount, for example, by displaying the remaining toner amount in a display portion 50 provided on the image forming apparatus 100. Here, a specific example for calculating the remaining toner amount by using the table of FIG. 5 is described. It is assumed that the time TO=0.6 [sec] in the state in which there is no toner T in the toner detecting portion 65 and the time TI=0.4 [sec] in the state in which there is toner T in the toner detecting portion 65. The CPU 124 calculates that the Duty ratio (TI/(TO+TI)) is 40%, and detects that the remaining toner amount is 15% by making reference to the table of FIG. 5. The CPU 124 carries out control so as to notify that the remaining toner amount is 15 [%], by the display portion 50. The engine controller 123 constitutes an acquiring portion for acquiring the remaining toner amount as an acquisition value based on the signal output by the capacitance detecting portion 80. Further, the display portion 50 constitutes a notifying portion for making notification of information on the remaining toner amount of the toner in the toner accommodating portion 60.

Incidentally, the CPU 124 may also carry out control so as to notify the remaining toner amount in the display portion of the external device 132 in place of or in addition to the notification of the remaining toner amount in the display portion 50 of the image forming apparatus 100. In this case, the notifying portion is constituted by a transmitting portion for transmitting information on the remaining toner amount toward the external device 132, or the like portion. Further, the information on the remaining toner amount is not limited to a value of the remaining toner amount, but the CPU 124 may also notify warning (message or the like) prompting the user to exchange the cartridge unit 15. Further, the notification of the information on the remaining toner amount is not limited to notification made by displaying the remaining toner amount or a message, but may also be performed by generation of voice by a voice generating portion, emission of light by a light emitting portion, or the like.

### Conversion of Output Voltage Vsns into Hi/Lo Pulse Signal

Using part (a) of FIG. 6, an example of conversion of Vsns_AD into the Hi/Lo pulse signal will be described. Part (a) of FIG. 6 is a schematic view showing the Vsns_AD and the Hi/Lo pulse signal converted from the Vsns_AD in a time-series manner.

In order to convert the Vsns_AD into the Hi/Lo pulse signal, a threshold voltage Vth for discriminating “Hi” and “Lo” is set between Vsns_AD in the state in which there is no toner T in the toner detecting portion 65 and Vsns_AD in the state in which there is toner T in the toner detecting portion 65. As an example of a calculating method of Vth, in this embodiment, the CPU 124 samples Vsns_AD corresponding to 1 (cyclic) period of a stirring period Tp in 1 ms, and then Vth is calculated by the following formula (5), in which an average of higher five sampled voltages is Vmax, an average of lower five sampled voltages is Vmin.

Vth=(Vmax−Vmin)/2 (5)

The CPU 124 is, for example, capable of calculating the threshold voltage Vth on the basis of the Vsns_AD acquired in a rotation state of the stirring member 63 after output voltage Vsns adjustment control described later and before a start of the remaining toner amount detection control (or immediately after the start of the remaining toner amount detection control). The CPU 124 causes the storing portion 126 to store the calculated threshold voltage Vth.

Then, the CPU 124 converts the Vsns_AD into the Hi/Lo pulse signal in a manner such that a voltage higher than the calculated threshold voltage Vth is defined as “Hi” and a voltage lower than the calculated threshold voltage Vth is defined as “Lo”.

### Problem

Part (a) of FIG. 6 shows an example of a waveform of the Vsns_AD in the case where a parameter determining the output voltage Vsns is a typical value such as a design value. As this parameter, it is possible to cite a distance and an area of electrodes constituting the capacitance portion 64 and opposing each other, variations in resistance value of the electrode, parasitic capacitance, the capacitance detecting portion or the like, a change in environment such as a temperature or a humidity, and the like. By the change in environment such as the temperature or the humidity, influences due to the electrode resistance value, the parasitic capacitance, the capacitance detecting portion, and the like change in some instances. In the case of part (a) of FIG. 6, both the Vsns_AD in the state in which there is no toner T in the toner detecting portion 65 and the Vsns_AD in the state in which there is toner T in the toner detecting portion 65 fall within a detection range 0 V to 3.3 V of the AD converter 125. For that reason, conversion to the Hi/Lo pulse signal is normally performed, and from the table stored in advance in the storing portion 126 and showing the relationship between the Duty ratio and the remaining toner amount, it is possible to detect the remaining toner amount according to an expected value.

Part (b) of FIG. 6 shows an example of a waveform of the Vsns_AD in the case where the resistance value or the parasitic capacitance of the electrodes constituting the capacitance portion 64 becomes high due to variations in parts, the change in environment, or the like, for example. In this case, the Vsns_AD in the state in which there is no toner T in the toner detecting portion 65 exceeds an upper-limit value of 3.3 V of the detection range of the AD voltage or 125 as indicated by a broken line. That is, part (b) of FIG. 6 shows a state in which the Vsns_AD of 3.3 V or more cannot be detected. The table showing the relationship between the Duty ratio stored in advance in the storing portion 126 and the remaining toner amount is based on the premise that the Vsns_AD falls within the detection range of 0 V to 3.3 V of the AD converter. For that reason, in the case of part (b) of FIG. 6, although it is originally desirable that the threshold voltage Vth is calculated on the basis of the Vsns_AD indicated by the broken line, a threshold voltage Vth1 is calculated on the basis of Vsns_AD indicated by a solid line. Compared with the Hi/Lo pulse surface converted with the threshold voltage Vth, a Hi/Lo pulse signal 1 converted with the threshold voltage Vth1 is detected so that the time TI is long and the time TO is short, and therefore, it becomes difficult to detect an accurate remaining toner amount. In the capacitance type in which the remaining toner amount is detected by the Duty of the pulse, it is desired that the output voltage Vsns (Vsns_AD) is caused to full within the detection range (0 V to 3.3 V in this embodiment) of the AD converter 125.

### Adjustment Control of Output Voltage Vsns

Next, an example of control for adjusting the output voltage Vsns (Vsns_AD) so as to fall within the detection range of the AD converter 125 (hereinafter, this control is referred to as “output voltage Vsns adjustment control”) will be described. The output voltage Vsns becomes a voltage value dropped in voltage corresponding to a DC convert flowing from a voltage (reference voltage Vref) of the (−) terminal of the operational amplifier 85 into the detecting resistor 83. The reference voltage Vref is adjustable by a control voltage Vref_cont output by the CPU 124. In this embodiment, the CPU 124 adjusts the reference voltage Vref by adjusting the Vref_cont, so that the output voltage Vsns is caused to fall within the detection range of the AD converter 125.

In this embodiment, the output voltage Vsns adjustment control is executed when the toner T inside the toner accommodating portion 60 is not stirred by the stirring member 63. As an example, in this embodiment, the output voltage Vsns adjustment control is executed before a start of the remaining toner amount detection control, such as during turning-on (ON) of a power source of the image forming apparatus 100 or during an initial operation after the exchange of the cartridge unit 15. That is, in this embodiment, the output voltage Vsns adjustment control is executed before stirring of the toner T inside the toner detecting portion 65 is started. By executing the output voltage Vsns adjustment control before the start of the remaining toner amount detection control, there is no need to provide a new sequence during the remaining toner amount detection control, and therefore, downtime of the remaining toner amount detection control can be reduced. Further, by executing the output voltage Vsns adjustment control immediately before the remaining toner amount detection control, such as immediately before the image formation, the output voltage Vsns can be timely adjusted according to the variation in parameter for determining the output voltage Vsns. For example, it is possible to execute the output voltage Vsns adjustment control in a preparation operation (pre-rotation operation) in which rotation of the photosensitive drum 48 immediately before the image formation is performed.

Thus, the output voltage Vsns adjustment control can be executed during the initial operation in the case where the power source of the image forming apparatus 100 is turned on (ON) or in the case where the door 43 (FIG. 1) for exchanging the cartridge unit 15 or the like is opened and closed. The initial operation is a calibration operation (such as image density control) and an operation (preparation operation) for performing hardware check or the like, which are executed during non-image formation in which formation of the image transferred on the recording material S and then is output is not carried out. The engine controller 123 is capable of detecting that the power source of the image forming apparatus 100 is turned on, and in addition, is capable of detecting at least one of opening and closing of the door 43 by an opening/closing sensor 110 (FIG. 1) as an opening/closing detecting means. Further, the output voltage Vsns adjustment control can be executed when the photosensitive drum 48 immediately before the start of the image formation is rotated.

Incidentally, for example, in the case where the capacitance is constituted by disposing a stirring rod consisting of two lead wire members in the toner accommodating portion 60, by rotating the stirring rod, a state in which there is toner between the two lead wire members and a state in which there is no toner between the two lead wire members are repeated, so that the output voltage Vsns oscillates. In the case of such a constitution, by executing the output voltage Vsns adjustment control before the rotation of the stirring rod, an effect similar to the above-described effect can be obtained.

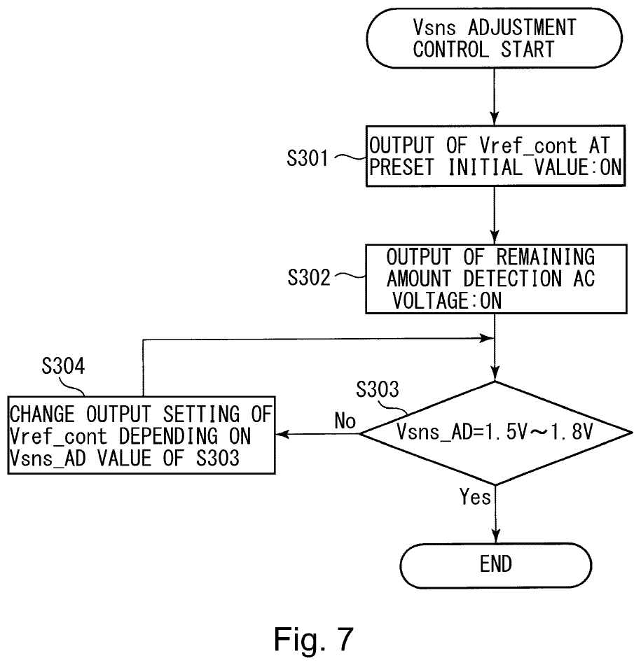

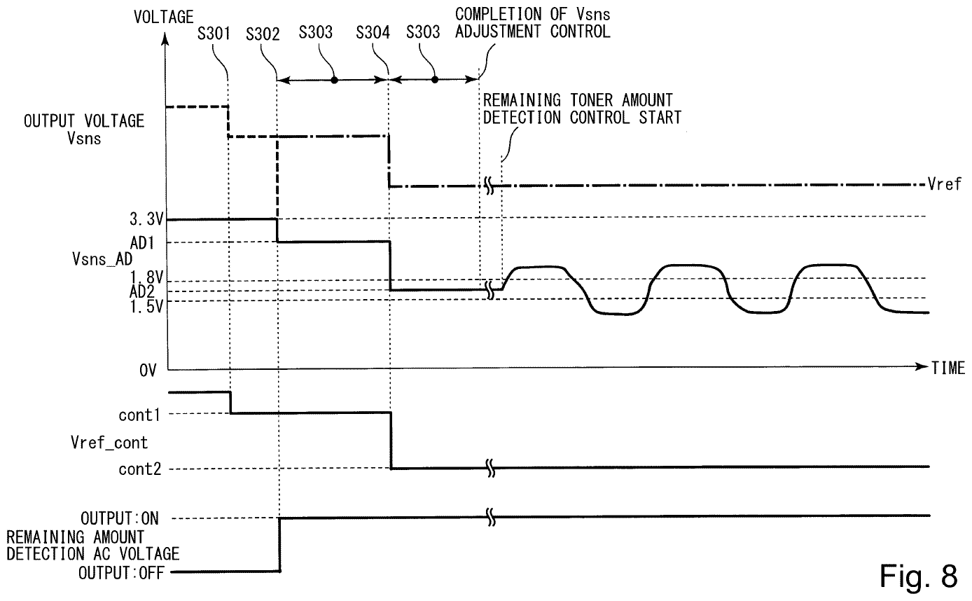

Using FIGS. 7 and 8, an example of a procedure of the output voltage Vsns adjustment control will be described. FIG. 7 is a flowchart for illustrating the procedure of the output voltage Vsns adjustment control. Further, FIG. 8 is a schematic view showing an example of a waveform of the output voltage Vsns of the capacitance detecting portion 80 for illustrating the procedure of the output voltage Vsns adjustment control, and shows respective signals in a time-series manner from the output voltage Vsns adjustment control until the remaining toner amount detection control is started. Step numbers S301 to S304 in FIG. 7 and those in FIG. 8 are timings corresponding to each other, respectively.

When the output voltage Vsns adjustment control is started, the CPU 124 outputs cont1 (value) which is a preset Vref_cont (S301). By this, a reference voltage Vref depending on the cont1 is inputted to the (+) terminal of the operational amplifier 85. At this time, the remaining amount AC voltage is not output, and therefore, the output voltage Vsns is the same voltage as the reference voltage Vref, and Vsns_AD becomes 3.3 V.

Next, the CPU 124 turns on (ON) output of the remaining amount AC voltage (S302). When the output of the remaining amount AC voltage is turned on, a current flows through the detecting resistor 83, and AD1 which is Vsns_AD dropped in voltage corresponding to a DC current flowing from the reference voltage Vref into the detecting resistor 83 is detected by the CPU 124. When the CPU 124 detects the AD1, the CPU 124 discriminates whether or not the Vsns_AD falls within a predetermined range set in advance (S303). In this embodiment, this predetermined range is 1.5 V to 1.8 V. An example of a setting method of the predetermined range will be described in a subsequent item.

When the Vsns_AD falls within the range of 1.5 V to 1.8 V, the CPU 124 ends the output voltage Vsns adjustment control and shifts the control to the remaining toner amount detection control. On the other hand, in the case where the Vsns_AD is not within the range of 1.5 V to 1.8 V, the CPU 124 changes the setting of the Vref_cont in the following manner (S304). That is, depending on a value of the Vsns_AD, the CPU 124 calculates Vref_cont at which the Vsns_AD becomes a value between 1.5 V and 1.8 V, and changes the setting of the Vref_cont. FIG. 8 shows an example in the case where a value of the AD1 is not within the range of 1.5 V to 1.8 V. As shown in FIG. 8, depending on the value of the AD1, the Vref_cont at which the Vsns_AD becomes a value between 1.5 V and 1.8 V is calculated, and the setting of the Vref_cont is changed to cont 2 calculated above. When the setting of the Vref_cont is changed to the cont2, the CPU 124 discriminates again whether or not the Vsns_AD is within the range of 1.5 V to 1.8 V (S303). FIG. 8 shows an example in the case where AD2 which is the Vsns_AD falling within the range of 1.5 V to 1.8 V when the Vref_cont is set to the cont2. Thereafter, the CPU 124 executes the remaining toner amount detection control in a setting (Vref_cont=cont2) in which the Vsns_AD becomes the AD2. Incidentally, the CPU 124 may discriminate that abnormality is detected in the case where the AD2 is not within the predetermined range of 1.5 V to 1.8 V or in the case where the AD2 is largely deviated from the predetermined range of 1.5 V to 1.8 V by exceeding a predetermined value. Then, in that case, the CPU 124 may also execute processing such as notification to the effect that the control is not shifted to the remaining toner amount detection control and that the remaining toner amount detection control is not appropriately performed, in the display portion 50 or the external device 132.

### Setting of Predetermined Range of Output Voltage Vsns

Next, an example of a setting method of a predetermined range of the output voltage Vsns will be described. In this embodiment, the predetermined range of the output voltage Vsns is set to 1.5 V to 1.8 V which is a range in consideration of a variation of ±0.15 V from 1.65 V which is a center value of the detection range of 0 V to 3.3 V of the AD converter 125.

First, a purpose of the output voltage Vsns adjustment control is to cause the output voltage Vsns in the state in which there is no toner T in the toner detecting portion 65 and the output voltage Vsns in the state in which there is toner T in the toner detecting portion 65 to fall within the detection range of 0 V to 3.3 V of the AD converter 125. During the execution of the remaining toner amount detection control, there is a possibility that the output voltage Vsns is fluctuated by disturbance noise, the change in environment such as the temperature or the humidity, and the like. For that reason, it is desired that the predetermined range of the output voltage Vsns is set to the range including the center voltage of the detection range of 0 V to 3.3 V of the AD converter 125 and that the output voltage Vsns is brought near to the center value of the detection range (0 V to 3.3 V) of the AD converter 125. By this, even when the output voltage Vsns is fluctuated during the execution of the remaining toner amount detection control, it is possible to suppress that the output voltage Vsns becomes out of the detection range of the AD converter 125. A voltage width relative to the center value can be appropriately set in consideration of calculation (computation) error and variations in parts, for example. In this embodiment, the voltage width is set to a value at which the number of repetition of the processing of S303 and the processing of S304 in FIG. 8 can be sufficiently made small and at which it is possible to sufficiently suppress that the output voltage Vsns becomes out of the detection range of the AD converter 125 during the execution of the remaining toner amount detection control.

Further, in this embodiment, in a state of the toner detecting portion 65 when the output voltage Vsns adjustment there are the case where the toner detecting portion 65 is filled with the toner and the case where the toner detecting portion 65 is not filled with the toner, so that an amount of the toner T in the toner detecting portion is not constant. For that reason, an output voltage Vsns after execution of the output voltage Vsns adjustment control becomes a value between the voltage (VO of FIG. 4) in the state in which there is no toner in the toner detecting portion 65 and the voltage (VI of FIG. 4) in the state in which there is toner T in the toner detecting portion 65.

A difference between VO and VI is referred to as ΔV, and an output voltage Vsns adjusted by the output voltage Vsns adjustment control is referred to as V2. At this time, in the case where the output voltage Vsns adjustment control is executed in the state in which there is no toner T in the toner detecting portion 65, the output voltage Vsns during the remaining toner amount detection control fluctuates in a range of V2 to V2−ΔV. On the other hand, in the case where the output voltage Vsns adjustment control is executed in the state in which there is toner T in the toner detecting portion 65, the output voltage Vsns during the remaining toner amount detection control fluctuates in a range of V2 to V2−ΔV. Accordingly, depending on a state of the toner detecting portion 65 during the execution of the output voltage Vsns adjustment control, an amplitude range of the output voltage Vsns during execution of the remaining toner amount detection control changes. For that reason, it is desired that a predetermined range of the output voltage Vsns is set to a range including a center value of a detection range of 0 V to 3.3 V of the AD converter 125 and the output voltage Vsns is caused to approach the center value of 0 V to 3.3 V of the AD converter 125. By this, irrespective of the amount of the toner T in the toner detecting portion 65, the output voltage Vsns during the execution of the remaining toner amount detection control can be caused to fall within the AD converter detection range of 0 V to 3.3 V.

From a viewpoint as described above, the predetermined range of the output voltage Vsns may preferably be set to a range of a predetermined voltage width, relative to the center value of the detection range of the AD converter 125, in consideration of the calculation error, the variations in parts, and the like as described above. However, for example, in the case where it is known in advance that a voltage fluctuation of the output voltage Vsns due to disturbance noise or in the like case, as a countermeasure against the disturbance noise, actin such that the predetermined range of the output voltage Vsns is set to a range lower in value than the center value of the detection range of the AD converter 125 may be taken. Further, the setting such that the output voltage Vsns falls within the predetermined range includes a setting such that the output voltage Vsns is set to a predetermined value such as the center value of the detection range of the AD convert or 125, for example.

In this embodiment, by causing the output voltage Vsns to fall within the range of 1.5 V to 1.8 V by the convert Vsns adjustment control, even in the case where the variation in parameter determining the output voltage Vsns is large, it is possible to cause the output voltage Vsns to fall within the detection range of the AD converter 125.

Incidentally, in this embodiment, although the number of adjustment of the Vref_cont is only one, the adjustment of the Vref_cont may also be executed plural times. For example, by using a change range of single setting of the Vref_cont as a predetermined change range, discrimination as to whether or not the output voltage Vsns falls within the predetermined range and the change in setting of the Vref_cont may also be repeated.

Further, in this embodiment, by carrying out variable control of the reference voltage Vref, the output voltage Vsns is adjusted. However, the output voltage Vsns may also be adjusted by another means when the means is capable of adjusting the output voltage Vsns in a manner such that the Vpp and the frequency f of the remaining amount detection AC voltage, and the detecting resistor 83 are variably controlled or the like. That is, the engine controller 123 adjusts the output voltage Vsns of the capacitance detecting portion 80 by variably controlling the reference voltage Vref compared with a voltage depending on the current flowing through the first electrode 61 and the second electrode 62, and thus is capable of shifting an output level of the capacitance detecting portion 80. In addition, the engine controller 123 causes the AC voltage output portion 70 to change gain by variably controlling at least one of the Vpp and the frequency f of the remaining amount AC voltage, and thus is capable of shifting the output level of the capacitance detecting portion 80. This is because by changing the gain of the capacitance detecting portion 80 through variable control of at least one of the Vpp and the frequency f of the remaining amount detection AC voltage, the current flowing toward the detecting resistor 83 through the first electrode 61 and the second electrode 62 can be changed. Further, the engine controller 123 causes the capacitance detecting portion 80 to change the gain by variably controlling a resistance value of the detecting resistor (electrical resistor) 83, and thus is capable of shifting the output voltage level of the capacitance detecting portion 80. The output level of the capacitance detecting portion 80 can be adjusted by variably controlling at least one of the reference voltage Vref, the Vpp of the remaining amount detection AC voltage, the frequency of the remaining amount detection AC voltage, and the resistance value of the detecting resistor 83. Two or more of these parameters may also be subjected to the variable control in an arbitrary combination.

Further, in this embodiment, a constitution in which the capacitance detecting portion 80 causes an I/V converting circuit including the operational amplifier 85 to convert the current flowing through the capacitance portion 64 to a voltage is employed. However, the capacitance detecting portion 80 may also be constituted so as to output a voltage or a current, which depends on the capacitance of the capacitance portion 64. For example, a constitution in which the current flowing through the capacitance portion 64 is directly inputted to the engine controller may be employed. In this case, a constitution in which the engine controller 123 has a function of at least a part of the capacitance detecting portion 80 may employed.

Further, in this embodiment, the cartridge unit 15 is detachably mountable to the apparatus main assembly 101, and for example, in the case where the remaining toner amount of the toner accommodating portion 60 becomes a predetermined value or less, the cartridge unit 15 is exchanged. However, the present disclosure is not limited to such a constitution. The image forming apparatus 100 may also have a constitution in which the toner is capable of being supplied to the toner accommodating portion 60.

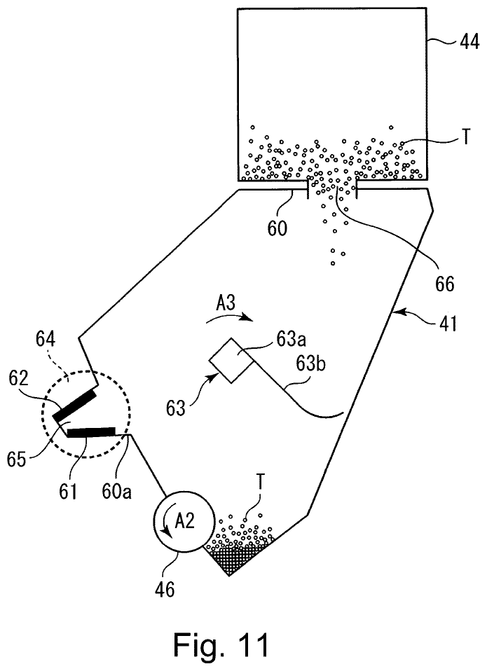

For example, as shown in FIG. 11, the image forming apparatus 100 is capable of employing a constitution in which the developing device 41 is provided with a supply opening 66 capable of permitting supply of the toner, and in which to this supply opening 66, the toner cartridge 44 which is a supply container is connected. Further, for example, in the case where the remaining toner amount of the toner accommodating portion 60 becomes the predetermined amount or less the toner cartridge 44 is connected to the supply opening 66 and thus the toner is supplied to the toner accommodating portion 60. Incidentally, the image forming apparatus 100 may be also employ a constitution in which the toner cartridge 44 is removed after the supply of the toner and then the image formation is carried out or a constitution in which the image formation is carried out in a state in which the toner cartridge 44 is mounted. In the former case, the toner cartridge 44 is mounted to and demounted from the developing device 41 when the toner is supplied. In the latter case, the supply of the toner may be performed at once immediately after the toner cartridge 44 is mounted to the developing device 41 (i.e., is exchanged), or may also be performed sequentially depending on consumption of the toner in the toner accommodating portion 60.

Thus, in this embodiment, the image forming apparatus 100 includes the developing device 41 including the roller (developing roller) 46 carrying the toner, the accommodating portion (toner accommodating portion 60 for accommodating the toner for being carried on the roller 46, the first electrode 61 and the second electrode 62 which are disposed opposed to each other in the accommodating portion 60, and the stirring member 63 which is the stirring member 63 for stirring the toner in the accommodating portion 60 and which is rotated so that the toner is supplied to between the first electrode 61 and the second electrode 62. Further, the image forming apparatus 100 includes the apparatus main assembly 101 in which the developing device 41 is mounted and which includes the voltage applying portion (AC voltage output portion) 70 for applying the AC voltage to the first electrode 61 and the second electrode 62, the output portion (capacitance detecting portion) 80 for outputting the signal depending on the capacitance between the first electrode 61 and the second electrode 62, the adjusting portion (engine controller) 123 for adjusting at least one of the output portion 80 and the voltage applying portion 70, the acquiring portion (engine controller) 123 for acquiring the acquisition value (remaining toner amount) based on the above-described signal, the notifying portion (display portion) 50 for notifying the information on the remaining toner amount of the toner in the accommodating portion 60 depending on the above-described acquisition value, and the controller (CPU) 124 for controlling the voltage applying portion 70, the output portion 80, the adjusting portion 123, and the acquiring portion 123. Further, in the case where the above-described signal output by the output portion 80 when the stirring operation by the stirring member 63 is performed is a first signal, the above-described acquisition value based on the first signal is a first acquisition value, and the above-described signal output by the output portion 80 when the stirring operation by the stirring member 63 is not performed is a second signal, the adjusting portion 23 adjusts at least one of the output portion 80 and the voltage applying portion 70 so that strength of the second signal falls within the predetermined range, and the notifying portion 50 provides the above-described notification depending on the first acquisition value based on the first signal output by the output portion 80 put in a state in which the above-described adjustment is performed and thus the second signal falls within the above-described predetermined range. Further, in this embodiment, the first acquisition value is a value based on the Duty ratio of the first signal. Further, in this embodiment, the developing device 41 is detachably mountable to the apparatus main assembly 101. However, the image forming apparatus 100 may also be provided with the supply opening 66 capable of permitting supply of the toner to the accommodating portion 60.

Further, in this embodiment, the above-described predetermined range is set to the range including the center value between the minimum value and the maximum value of the strength of the above-described signal capable of being detected by the acquiring portion 123. Further, in this embodiment, the output portion 80 includes the converting portion (detecting resistor) 83 for converting the current flowing through the first electrode 61 and the second electrode 62 into the voltage, and includes the reference power source 86 for outputting the reference voltage Vref, and outputs the above-described signal depending on the voltage obtained by subtracting the reference voltage Vref from the voltage converted by the converting portion 83, and the adjusting portion 123 adjusts the output portion 80 so that the reference voltage Vref output by the reference power source 86 is changed in the above-described adjustment. However, a constitution in which the adjusting portion 123 adjusts the voltage applying portion 70 so that at least one of the voltage value and the frequency of the AC voltage applied to the first electrode 61 and the second electrode 62 by the voltage applying portion 70 in the above-described adjustment is changed may also be employed. Further, a constitution in which the output portion 80 includes the resistor (detecting resistor) 83 for converting the current flowing through the first electrode 61 and the second electrode 62 into the voltage and in which the adjusting portion 123 adjusts the output portion 80 so that the resistance value of the resistor 83 is changed in the above-described adjustment may also be employed. Further, the adjusting portion 123 is capable of performing the above-described adjustment before the image formation is started in the case where the power source of the image forming apparatus 100 is turned on. Further, the image forming apparatus 100 may include the openable/closable door 43 enabling access to the inside of the image forming apparatus 100 and the sensor (opening/closing sensor) 110 for detecting the opening/closing the door 43, and the adjusting portion 23 is capable of performing the above-described adjustment on the basis of detection of the opening of the door 43 by the sensor 110. Further, the adjusting portion 123 is capable of performing the above-described adjustment in the preparation operation (pre-rotation step) immediately before the image formation is started.

As described above, according to this embodiment, by the change in parameter relating to the output voltage Vsns, it is possible to suppress that the detection accuracy of the remaining toner amount lowers and that the remaining toner amount cannot be detected. Accordingly, according to this embodiment, in a constitution in which the information on the remaining toner amount is acquired by the capacitance type (system), irrespective of the variation in parts, the change in environment, and the like, it is possible to maintain the accuracy of the information on the acquired remaining toner amount.

### Embodiment 2

### Setting of Abnormality Discrimination Threshold Voltage

Next, another embodiment of the present disclosure will be described. Basic constitution and operation of an image forming apparatus of this embodiment are the same as those of the image forming apparatus of the embodiment 1. Accordingly, in the image forming apparatus of this embodiment, elements having identical or corresponding functions or constitutions to those of the image forming apparatus 100 of the embodiment 1 will be omitted from detailed description by adding thereto the same reference numerals or symbols as those in the embodiment 1.

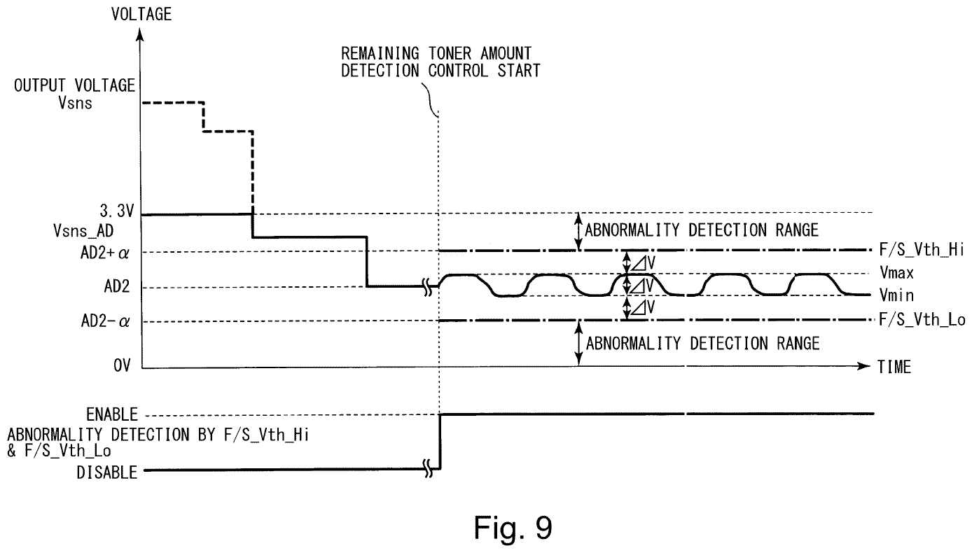

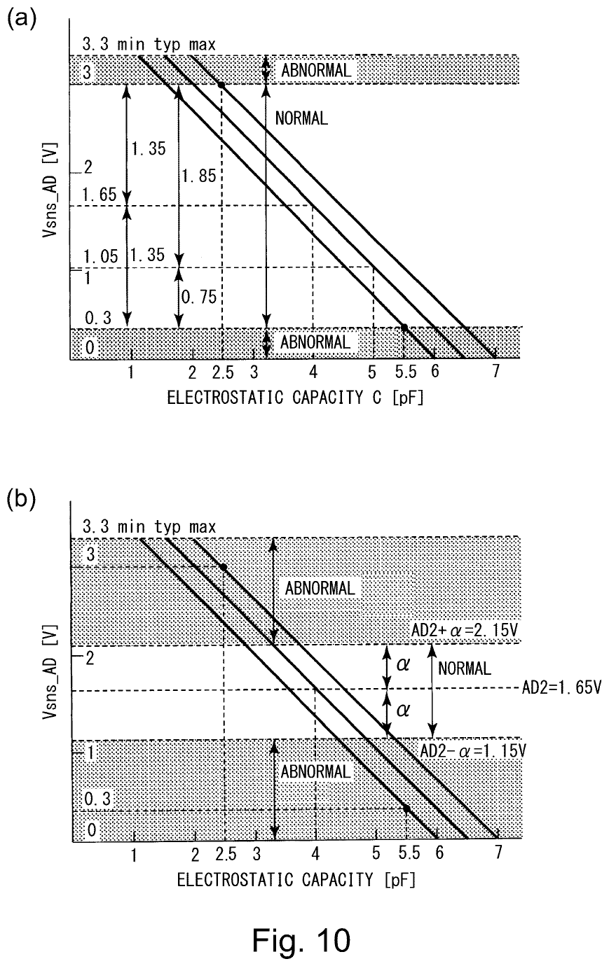

FIG. 9 is a schematic view showing an example of a waveform of an output voltage Vsns of the capacitance detecting portion 80 when Vsns_AD is adjusted to AD2 by the output voltage Vsns adjustment control described in the embodiment 1 and then the remaining toner amount detection control is started.

In this embodiment, the CPU 124 determines the AD2 by the output voltage Vsns adjustment control and then calculates an abnormality discrimination threshold voltage on the basis of a value of the AD2. For example, AD2+α and AD2−α are calculated as the abnormality discrimination threshold voltages. The AD2+α is also referred to as an “F/S_Vth_Hi”. Further, the AD2−α is also referred to as an “F/S_Vth_Lo”. The calculated abnormality discrimination threshold voltages are reflected when the output voltage Vsns adjustment control is completed and the remaining toner amount detection control is started. Then, abnormality discrimination in which each of a voltage higher than the F/S_Vth_Hi and a voltage lower than the F/S_Vth_Lo is defined as an abnormality detection range is enabled. The CPU 124 is capable of taking for example, the following countermeasures in the case where a value of the Vsns_AD is higher than the abnormality discrimination threshold voltage F/S_Vth_Hi or is lower than the abnormality discrimination threshold voltage FS_Vth_Lo. That is, the CPU 124 is capable of carrying out control so as to disable the remaining toner amount detection control. Further, the CPU 124 is capable of disabling the remaining toner amount detection control and is capable of starting the control again from the output voltage Vsns adjustment control after a lapse of a certain time. The disablement of the remaining toner amount detection control may be that the voltage is not applied to the first electrode 61 and the second electrode 62, that calculation (computation) acquiring the remaining toner amount is not performed, that notification of the remaining toner amount is not provided, that abnormality of the detection of the remaining toner amount is notified, or the like. As the disablement of the remaining toner amount detection control, the CPU 124 may perform at least one of these. Thus, the CPU 124 is capable of executing processing for suppressing erroneous detection of the remaining toner amount in the case where the Vsns_AD is fluctuated by short-circuit of a signal line of the output voltage Vsns and the disturbance noise or in the like case.

A numerical value of α is set to, for example, a value higher than a voltage difference (ΔV) between Vsns_AD in the state in which there is no toner T in the toner detecting portion 65 and Vsns_AD in the state in which there is toner T in the toner detecting portion 65. The Vsns_AD in the state in which there is no toner T in the toner detecting portion 65 can be said as a maximum value Vmax of the Vsns_AD after the adjustment. In addition, the Vsns_AD in the state in which there is toner T in the toner detecting portion 65 can be said as a minimum value Vmin of the Vsns_AD after the adjustment. In this embodiment, the AD2 which is Vsns_AD adjusted by the output voltage Vsns adjustment control is acquired before the stirring member 63 stirs the toner T. For that reason, it is unclear whether the adjustment is made in the state in which there is toner T in the toner detecting portion 65 or in the state in which there is no toner in the toner detecting portion 65. During execution of the remaining toner amount detection control, the toner T is stirred by the stirring member 63, so that as shown in FIG. 9, an amplitude ΔV is generated in the Vsns_AD relative to the adjusted AD2. For that reason, a range wider than AD2−ΔV to AD2+ΔV is set as a normal range, so that erroneous abnormality detection is suppressed and thus the remaining toner amount detection control can be normally carried out. Incidentally, a setting method of α in this embodiment is an example, and a value different from α may also be set.

Using parts (a) and (b) of FIG. 10, a difference in abnormality detection between the case where the output voltage Vsns adjustment control is executed (this embodiment) and the case where the output voltage Vsns adjustment control is not executed (comparison example) will be described. Each of parts (a) and (b) of FIG. 10 is a graph showing a relationship between the capacitance of the capacitance portion 64 and the Vsns_AD, in which the ordinate represents the Vsns_AD and the abscissa represents the capacitance of the capacitance portion 64. It is assumed that the Vsns_AD has a variation in characteristic between min (minimum value characteristic) and max (maximum value characteristic) as shown in parts (a) and (b) of FIG. 10 due to a variation in parameter determining the output voltage Vsns. Incidentally, each of parts (a) and (b) of FIG. 10 shows the case where it is desired that the case where the capacitance of the capacitance portion 64 is out of a range of 2.5 pF to 5.5 pF is an abnormality detection range. Part (a) of FIG. 10 shows the above-described relationship of the case where the output voltage Vsns adjustment control is not executed (comparison example). Further, part (b) of FIG. 10 shows the above-described relationship of the case where the output voltage Vsns adjustment control is executed (this embodiment).

As shown in part (a) of FIG. 10, in the case where the output voltage Vsns adjustment control is not executed, the abnormality detection range is set in the following manner in consideration of the parameters determining the output voltage Vsns.

That is, a range of not less than 3 V which is a maximum value of the Vsns_AD in the case where the capacitance of the capacitance portion 64 is 2.5 pF and a range of not more than 0.3 V which is a minimum value of the Vsns_AD in the case where the capacitance of the capacitance portion 64 is 5.5 pF are set as the abnormality detection range. As an example, in the case where the characteristic of the Vsns_AD is type characteristic between the min characteristic and the max characteristic, the value of the Vsns_AD when the capacitance of the capacitance portion 64 is 1.65 V. For that reason, in this case, abnormality is detected when a voltage fluctuation such that the Vsns_AD becomes high by 1.35 V or more or that the Vsns_AD becomes low by 1.35 V or more generates. Further, in the case of the type characteristic, the value of the Vsns_AD when the capacitance of the capacitance portion 64 is 5 pF is 1.05 V. For that reason, in this case, abnormality is detected when a voltage fluctuation such that the Vsns_AD becomes high by 1.85 V or more or that the Vsns_AD becomes low by 0.75 V or more generates. Thus, in the case where the output voltage Vsns adjustment control is not executed, due to variations in parameter determining the capacitance of the capacitance portion 64 and the output voltage Vsns, a voltage fluctuation amount of the Vsns_AD leading to the abnormality detection varies. As a specific example, there is a possibility that the following phenomenon occurs. That is in the case of the type characteristic, the abnormality is detected by the voltage fluctuation such that the Vsns_AD becomes high by 1.35 V when the capacitance of the capacitance portion 64 is 4 pF. However, in the case of the type characteristic, when the capacitance of the capacitance portion 64 is 5 pF, in a voltage fluctuation similar to the above-described voltage fluctuation such that the Vsns_AD becomes high by 1.35 V, the abnormality is not detected.

As shown in part (b) of FIG. 10, in the case where the output voltage Vsns adjustment control is executed, irrespective of the variations in parameter determining the capacitance of the capacitance portion 64 and the output voltage Vsns, the value of the Vsns_AD is adjusted to the AD2. For that reason, there is no need to set the abnormality detection range in consideration of the variations in parameter determining the capacitance of the capacitance portion 64 and the output voltage Vsns. As an example, in the case where the AD2 is 1.65 V and α is 0.5 V, the abnormality is detected when a voltage fluctuation such that the Vsns_AD becomes high by 0.5 V or more or becomes lower by 0.5 V or more irrespective of the variation in parameter determining the output voltage Vsns generates. Thus, in the case where the output voltage Vsns adjustment control is executed, the voltage fluctuation amount of the Vsns_AD leading to the abnormality detection is not changed by the variations in parameter determining the capacitance of the capacitance portion 64 and the output voltage Vsns. Further, by changing a set value of α, it is possible to change the abnormality detection range. For that reason, the abnormality detection range in conformity to design concept or the like can be set so as to enable discrimination between normality and abnormality with sufficient accuracy. By this, irrespective of the variations in parameter determining the capacitance of the capacitance portion 64 and the output voltage Vsns, it is possible to accurately perform the abnormality detection.

Thus, by executing the output voltage Vsns adjustment control, it is possible to appropriately set the abnormality detection range in which the abnormality can be detected irrespective of the parameters determining the capacitance of the capacitance portion 64 and the output voltage Vsns. For that reason, compared with the case where the output voltage Vsns adjustment control is not carried out, in the case where the output voltage Vsns adjustment control is executed, discrimination between the normality and the abnormality can be accurately performed.

Thus, the controller 124 is capable of setting the abnormality range of strength of a first signal (signal output by the output portion 80 when the stirring operation is performed) for detecting the abnormality of the acquisition value (remaining toner amount) on the basis of strength of a second signal (signal output by the output portion 80 when the stirring operation is not performed), falling within a predetermined range by the adjustment by the adjusting portion 123. Further, in the case where the first signal of which strength falls within in the abnormality range is detected, the controller 124 is capable of carrying out control so as to disable notification of the acquisition value by the notifying portion (display portion) 50. At this time, the controller 124 is capable of setting, as the abnormality range, strength of the first signal larger than strength obtained by adding a predetermined value to the strength of the second signal falling within the above-described predetermined range, by the above-described adjustment. Further, the controller 124 is capable of setting, as the abnormality range, strength of the first signal smaller than strength obtained by subtracting a predetermined value from the strength of the second signal falling within the above-described predetermined range, by the above-described adjustment.

As described above, according to this embodiment, the abnormality detection accuracy is improved, so that it is possible to suppress erroneous detection of the remaining toner amount and that a state in which the remaining toner amount detection cannot be made is formed.

According to the present disclosure, in the case in which the information on the remaining toner amount is acquired by the capacitance system, irrespective of the variations in parts, the change in environment, or the like, accuracy of the acquired information on the remaining toner amount can be maintained.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-022911, filed on Feb. 14, 2025, which is hereby incorporated by reference herein in its entirety.

What is claimed is:

1. An image forming apparatus comprising:
(i) a developing device including:
a roller that carries toner;
an accommodating portion configured to accommodate the toner for being carried on the roller;
a first electrode and a second electrode opposed to each other in the accommodating portion; and
a stirring member configured to stir the toner in the accommodating portion, wherein the stirring member is rotated so that the toner is supplied to between the first electrode and the second electrode; and
(ii) a main assembly to which the developing device is mounted, the main assembly including:
a voltage applying portion configured to apply an AC voltage to the first electrode and the second electrode;
an output portion configured to output a signal depending on capacitance between the first electrode and the second electrode;
an adjusting portion configured to adjust at least one of the output portion and the voltage applying portion;
an acquiring portion configured to acquire an acquisition value based on the signal;
a notifying portion configured to notify information on a remaining toner amount of the accommodating portion, depending on the acquisition value;
and a controller configured to control the voltage applying portion, the output portion, the adjusting portion, and the acquiring portion,
wherein in a case where a signal output by the output portion when a stirring operation by the stirring member is performed is a first signal, an acquisition value based on the first signal is a first acquisition value, and a signal output by the output portion when the stirring operation is not performed is a second signal,
(a) the adjusting portion makes adjustment of at least one of the output portion and the voltage applying portion so that strength of the second signal falls within a predetermined range, and
(b) the notifying portion makes notification depending on the first acquisition value based on the first signal output by the output portion in a state in which the adjustment is made and the strength of the second signal is within the predetermined range.

2. The image forming apparatus according to claim 1, wherein the first acquisition value is a value based on a duty ratio of the first signal.

3. The image forming apparatus according to claim 1, wherein the developing device is detachably mountable to the main assembly.

4. The image forming apparatus according to claim 1, wherein the accommodating portion is provided with a supply opening through which the toner is capable of being supplied thereto.

5. The image forming apparatus according to claim 1, wherein the predetermined range is set to a range including a center value between a minimum value and a maximum value of the strength of the signal detectable by the acquiring portion.

6. The image forming apparatus according to claim 1, wherein the output portion includes a converting portion for converting a current flowing through the first electrode and the second electrode into a voltage, and a reference power source for outputting a reference voltage,
wherein the output portion outputs the signal depending on a voltage obtained by subtracting the reference voltage from the voltage converted by the converting portion, and
wherein the adjusting portion adjusts the output portion in the adjustment so that the reference voltage output by the reference power source is changed.

7. The image forming apparatus according to claim 1, wherein the adjusting portion adjusts the voltage applying portion in the adjustment so that at least one of a voltage value and a frequency of the AC voltage is changed.

8. The image forming apparatus according to claim 1, wherein the output portion includes a resistor for converting a current flowing through the first electrode and the second electrode into a voltage, and
wherein the adjusting portion adjusts the output portion in the adjustment so that a resistance value of the resistor is changed.

9. The image forming apparatus according to claim 1, wherein in a case where a power source of the image forming apparatus is turned on, the adjusting portion makes the adjustment before image formation is started.

10. The image forming apparatus according to claim 1, further comprising an openable/closable door that enables access to an inside of the image forming apparatus, and a sensor configured to detect opening/closing of the door,
wherein the adjusting portion makes the adjustment on the basis of detection of the opening of the door by the sensor.

11. The image forming apparatus according to claim 1, wherein the adjusting portion makes the adjustment in a preparation operation immediately before image formation is started.

12. The image forming apparatus according to claim 1, wherein the controller sets an abnormality range of strength of the first signal for detecting abnormality of the acquisition value, on the basis of the strength of the second signal adjusted so as to fall within the predetermined range by the adjustment.

13. The image forming apparatus according to claim 12, wherein in a case where the first signal having the strength within the abnormality range is detected, the controller carries out control so as to disable the notification by the notifying portion.

14. The image forming apparatus according to claim 12, wherein the controller sets strength of the first signal, higher than strength obtained by adding a predetermined value to the strength of the second signal adjusted so as to fall within the predetermined range by the adjustment, to the abnormality range.

15. The image forming apparatus according to claim 12, wherein the controller sets strength of the first signal, lower than strength obtained by subtracting a predetermined value from the strength of the second signal adjusted so as to fall within the predetermined range by the adjustment, to the abnormality range.
